(19) United States
(12) Patent Application Publication
(10) Pub. No.: US 2006/0243100 A1
(43) Pub. Date: Nov. 2, 2006

(54) Nut, a tool and a method for elongating and relaxing a stud and the like

(76) Inventors: Jason Junkers, Park Ridge, NJ (US); Peter Koppenhoefer, Portland, PA (US)

Correspondence Address: STRIKER, STRIKER & STENBY, 103 EAST NECK ROAD, HUNTINGTON, NY, 11743, US

(21) Appl. No.: 11/116,031

(22) Filed: Apr. 27, 2005

(51) Int. Cl. B25B 17/00; B25B 29/02; B25B 13/46

(52) U.S. Cl. 81/57.38; 81/57.39

(57) ABSTRACT

For elongating and relaxing a stud arranged in an object, the stud of a fastener part is engaged by a tool part of a power tool, and the fastener part is operated by a pawl-ratchet mechanism including a pawl provided in the tool part and a ratchet provided in the fastener part and turnable by the pawl in a ratcheting fashion.

### BACKGROUND OF THE INVENTION

The present invention relates to a nut for elongating or relaxing studs, bolts, and the like, as well as to a tool for and a method for the same.

More particularly, the present invention can deal with such a nut which has an outer sleeve, an inner sleeve engaging with the outer sleeve and also engaging with a stud, the bolt and the like, and a washer element connected with the inner sleeve and not connected with the outer sleeve, so that when equal and opposite forces are applied to the washer and to the outer sleeve, the outer sleeve turns, while the inner sleeve moves only in an axial direction to move the stud, the bolt and the like in the axial direction so as to elongate or to relax it.

Such nuts, as well as power tools and methods are disclosed in my U.S. Pat. Nos. 5,318,397; 5,341,560; 5,539,970; 5,946,789 and 6,461,093. In the above mentioned patents power tools incorporating a complete ratchet-pawl mechanism are utilized. It is believed that the existing nuts as well as the power tools and methods for actuating fasteners provided with the nuts can be further improved.

### SUMMARY OF THE INVENTION

Accordingly, it is an object of the present invention to provide a nut for elongating and relaxing a stud, and also a tool and a method for the same.

In keeping with these objects and with others which will become apparent hereinafter, one feature of the present invention resides, briefly stated, in a nut for elongating and relaxing a stud arranged in an object, comprising a nut member which is formed as a ratchet which is engageable with and turnable in a ratcheting manner by a pawl of a power tool so that said ratchet of the nut and said pawl of the power tool together form a pawl-ratchet mechanism.

In accordance with the present invention another feature of the present invention resides in a power tool for elongating and relaxing a stud arranged in an object, comprising a tool part with a power drive and a pawl; and a fastening part engageable with the stud for elongating and relaxing the stud and being provided with a ratchet which is engageable with and turnable in a ratcheting manner by said pawl of said tool part, so that said pawl of said tool part and said ratchet of said fastener part together form a pawl-ratchet mechanism.

Still another feature of the present invention resides in a method of elongating and relaxing a stud arranged in an object, comprising the steps of providing a tool part having a power drive and a pawl; engaging the stud with a fastener part for elongating and relaxing the stud, which fastener part has a ratchet; and engaging said ratchet of said fastener part by said pawl of said tool part and turning said ratchet in a ratcheting manner, so that said pawl of said tool part and said ratchet of said fastener part together form a pawl-ratchet mechanism.

When the nut and the power tool are designed in accordance with the present invention and a method is performed in accordance with the present invention, the power tool has a simpler and less expensive construction because it does not have a ratchet, while the nut cost is substantially the same because the nut needs engagement means with the tool which in this case is provided by ratchet teeth of the nut member of the nut.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a nut screwed on a stud arranged in an object, in accordance with the present invention;

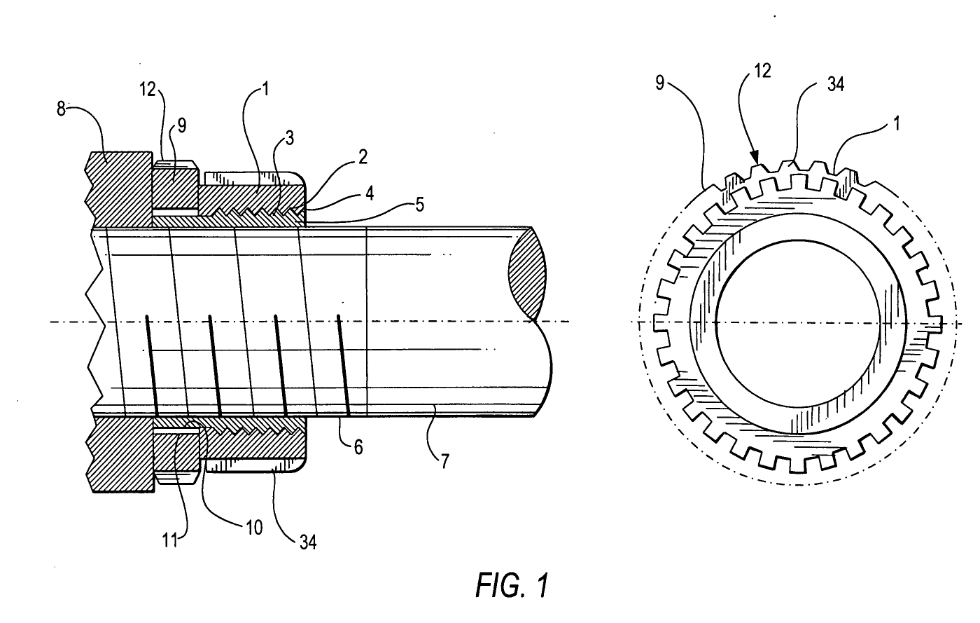

FIG. 2 is a side view of a power tool with a fastener in accordance with the present invention; and

FIG. 3 is an end view of the power tool and the fastener shown in FIG. 2 in accordance with the present invention.

### DESCRIPTION OF THE PREFERRED EMBODIMENTS

A nut of a fastener in accordance with an embodiment of the present invention shown in the drawings, has an outer sleeve which is identified with reference numeral 1 and has inner engaging formations 2 formed for example as a thread. The nut further has an inner sleeve 3 which has outer engaging formations formed for example as a thread 4 engaging with the thread 2 of the outer sleeve 1. The inner sleeve also has inner engaging formations formed as a thread 5 which engages with an outer thread 6 of a stud 7 introduced into an object 8. The nut further has a washer 9 which has engaging formations 10 interacting with engaging formations 11 of the inner sleeve 3, so that the washer 9 can not turn relative to the inner sleeve 3. The engaging formations 10 and 11 can be formed for example as interengaging splines. The washer 9 further has outer engaging formations 12 formed for example as external splines.

The nut in accordance with the present invention operates in the following manner:

When a power tool is applied to the nut so that a non-rotatable part of the power tool engages the washer 9 so as to at least hold the washer non-rotatably, while a rotatable part of the power tool turns the outer sleeve 1, the inner sleeve 3 can not turn but instead is displaced only in an axial direction, and thereby the stud 7 also displaces in an axial direction so as to elongate or to relax.

In order to hold the washer 9 non-rotatably and to turn the outer sleeve 1, a power tool is provided which has a power drive 21. The power drive 21 includes a cylinder 22 which defines an inner chamber 23, and a piston 24 which is displaceable in the inner chamber 23 of the cylinder 22 in response to supply of a pressurized fluid at a corresponding side of the piston 24. The piston 24 has a piston rod 25 and moves reciprocatingly with the latter.

The power tool is provided for operating the fastener so as to at least hold the washer 9 and to turn the outer sleeve 1. For this purpose, a pawl-ratchet mechanism is provided.

In accordance with the present invention the pawl-ratchet mechanism includes a pawl which is identified with reference numeral 31 and forms a part of the power tool. The pawl 31 is turnably connected at its one end with the piston rod 25 and has engaging formations formed for example by two teeth 32 and 33 at the opposite side. A ratchet of the pawl-ratchet mechanism is formed by the outer sleeve 1. For this purpose the outer sleeve 1 is provided with a plurality of ratchet teeth identified with reference numeral 34 and formed on its periphery. The tooth 32 of the pawl 31 which can be formed as a pushing tooth, and the tooth 33 of the pawl 26 which can be formed as a pulling tooth and engageable with the teeth 34 of the outer sleeve 1.

During the operation when the piston 24 with the piston rod 25 are displaced in one direction, the pushing tooth 32 of the pawl 31 engages between the teeth 34 of the outer sleeve 1 and pushes the sleeve 1, for example in a clockwise direction, while when the piston 24 with the piston rod 25 are displaced in an opposite direction the pulling tooth 33 engages between the teeth 34 of the ratchet sleeve 1 and pulls the outer sleeve 1 also in the same clockwise direction, to provide a continuous rotation of the outer sleeve 1.

It is therefore believed to be clear that in accordance with the present invention the pawl-ratchet mechanism 4 which converts the displacement of the piston into turning of the nut includes the pawl provided exclusively in the tool part and the ratchet located exclusively in the fastener part.

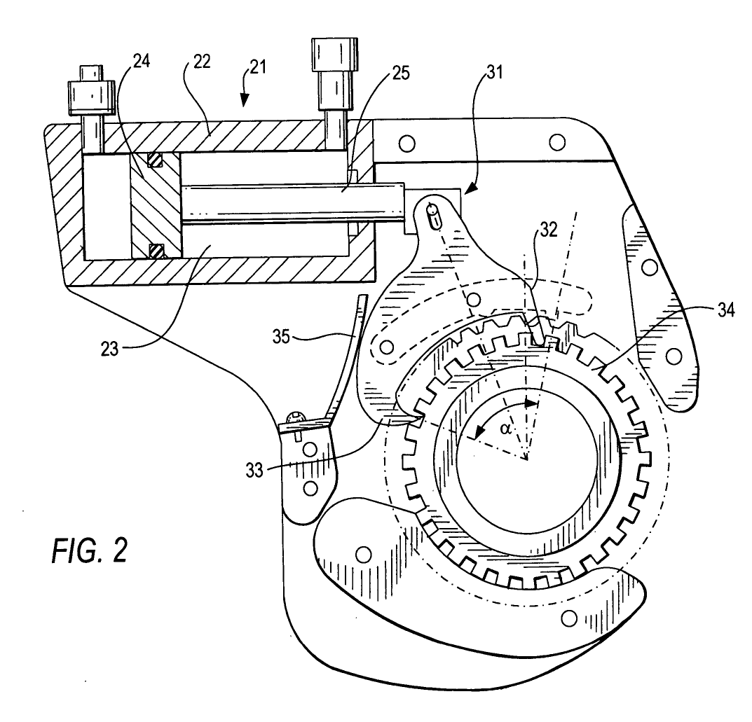

As can be seen from the drawings, a leaf spring 35 is provided to maintain the engagement of the pawl 31 with the teeth 34 of the outer sleeve 1 as can be seen from FIG. 2.

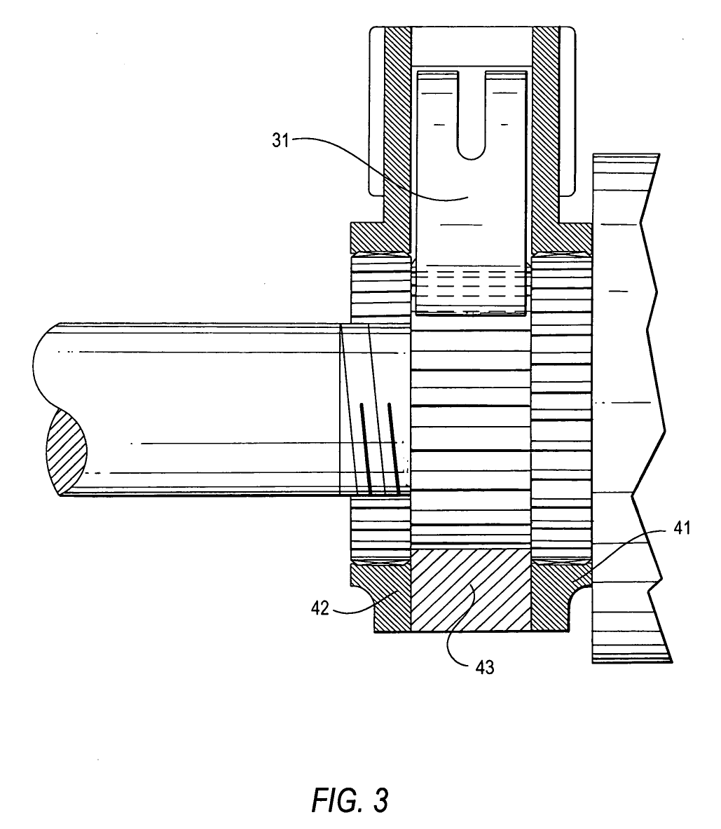

As can be also seen from FIG. 3, a side plate 41 which forms an immovable part of the housing of the power tool is engaged with the splines 12 of the washer 9, while an opposite side plate 42 is not engaged. A spacer 43 is provided between the side plate 41 and 42 to backup on the outer diameter of the nut. When for example an active turning force is applied by the pawl 31 to the outer sleeve 1 formed as the ratchet with the ratchet teeth 34, an opposite reaction force is generated in the housing and in the side plate 41 which at least holds the washer 9 from turning, with the action force and the reaction force being equal to one another.

It is to be understood that the nut and the fastener in this invention can be also different from those shown in the drawings and described above.

It will be understood that each of the elements described above, or two or more together, may also find a useful application in other types of constructions and methods differing from the types described above.

While the invention has been illustrated and described as embodied in a nut for elongating and relaxing a stud, and a tool for and a method of actuating the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A nut for elongating and relaxing a stud arranged in an object, comprising a nut member which is formed as a ratchet which is engageable with and turnable in a ratcheting manner by a pawl of a power tool so that said ratchet of the nut and said pawl of the power tool together form a pawl-ratchet mechanism.

2. A nut as defined in claim 1, wherein said ratchet is formed as an outer sleeve having inner engaging formations; and further comprising an inner sleeve having outer engaging formations which engage with said inner engaging formations of said outer sleeve and also having inner engaging formations which engage with a thread of the stud; and a washer arranged between said outer sleeve and the object so that said inner sleeve is non-rotatable relative to said washer while said outer sleeve is rotatable relative to said washer, so that when at least a holding force is applied to said washer and an opposite active force is applied to said outer sleeve to turn said outer sleeve, said inner sleeve does not turn but instead is moved only in an axial direction to elongate or relax the stud.

3. A nut as defined in claim 2, wherein said outer sleeve has an outer peripheral surface and is provided on said outer peripheral surface with a plurality of ratchet teeth.

4. A nut as defined in claim 2, wherein said washer is provided with engaging formations engageable by a tool for applying at least the holding force to said washer.

5. A power tool for elongating and relaxing a stud arranged in an object, comprising a tool part with a power drive and a pawl; and a fastening part engageable with the stud for elongating and relaxing the stud and being provided with a ratchet which is engageable with and turnable in a ratcheting manner by said pawl of said tool part, so that said pawl of said tool part and said ratchet of said fastener part together form a pawl-ratchet mechanism.

6. A power tool as defined in claim 5, wherein said fastener part includes an outer sleeve having inner engaging formations, an inner sleeve having outer engaging formations which engage with said inner engaging formations of said outer sleeve and also having inner engaging formations which engage with a thread of the stud, and a washer arranged between said outer sleeve and the object so that said inner sleeve is non rotatable relative to said washer while said outer sleeve is rotatable relative to said washer, so that when at least a holding force is applied to said washer and an opposite active force is applied to said outer sleeve to turn said outer sleeve, said inner sleeve does not turn but instead is moved only in an axial direction to elongate or relax the stud, wherein said outer sleeve of said fastener part is formed as said ratchet which is engageable with and turnable in a ratcheting manner by said pawl of said tool part.

7. A power tool as defined in claim 6, wherein said outer sleeve has an outer peripheral surface and is provided on said outer peripheral surface with a plurality of ratchet teeth.

8. A power tool as defined in claim 6, wherein said washer is provided with engaging formations engageable by the tool for at least holding the washer non-rotatably.

9. A method of elongating and relaxing a stud arranged in an object, comprising the steps of providing a tool part having a power drive and a pawl; engaging the stud with a fastener part for elongating and relaxing the stud, which fastener part has a ratchet; and engaging said ratchet of said fastener part by said pawl of said tool part and turning said ratchet in a ratcheting manner, so that said pawl of said tool part and said ratchet of said fastener part together form a pawl-ratchet mechanism.

10. A method as defined in claim 9; and further comprising providing in said fastener part an outer sleeve having inner engaging formations, an inner sleeve having outer engaging formations which engage with said inner engaging formations of said outer sleeve and also having inner engaging formations which engage with a thread of the stud, and a washer arranged between said outer sleeve and the object so that said inner sleeve is non-rotatable relative to said washer while said outer sleeve is rotatable relative to said washer; applying at least a holding force to said washer and an opposite active force to said outer sleeve, so that said inner sleeve does not turn but instead is moved only in an axial direction to elongate or relax the stud; and forming said outer sleeve of said fastener part as said ratchet which is engageable with and turnable in a ratcheting manner by said pawl of said tool part.
